(19) United States
(12) Patent Application Publication
(10) Pub. No.: US 2025/0350346 A1
(43) Pub. Date: Nov. 13, 2025

(54) CONSOLIDATION OF AIR-TO-GROUND VOICE LINKS FOR REMOTELY SUPERVISED AIRCRAFT AND ATC COMMUNICATIONS

(71) Applicant: Wisk Aero LLC, Mountain View, CA (US)

(72) Inventors: Mark R. Williamson, New Bern, NC (US); Craig Scheffler, Estes Park, CO (US)

(73) Assignee: Wisk Aero LLC, Mountain View, CA (US)

(21) Appl. No.: 19/202,809

(22) Filed: May 8, 2025

Related U.S. Application Data
(60) Provisional application No. 63/644,073, filed on May 8, 2024.

(51) Int. Cl. H04B 7/185; G08G 5/26

(52) U.S. Cl. CPC H04B 7/18508; G08G 5/26

(57) ABSTRACT

Methods, systems, and non-transitory, machine-readable media may facilitate air/ground voice links for remotely supervised aircraft and air traffic control communications. A three-dimensional (3D) geometry of a radio frequency (RF) service volume may be determined. Position information indicating a current position for each aircraft of a plurality of aircraft may be received. Based on the 3D geometry of the RF service volume and the position information, a subset of the plurality of aircraft may be determined to be within the RF service volume. One aircraft may be selected as an airborne repeater within the RF service volume. Routing of voice communications between one or more ground supervisor terminals and an ATC system for the subset of aircraft may be consolidated. The consolidating may include deactivating any air/ground voice link associated with aircraft of the subset of aircraft other than the one aircraft selected as the airborne repeater.

### CROSS-REFERENCE TO RELATED APPLICATIONS

This application claims benefit under 35 USC § 119 (e) to U.S. Provisional Patent Application No. 63/644,073 filed May 8, 2024, and entitled “CONSOLIDATION OF AIR-TO-GROUND VOICE LINKS FOR REMOTELY OPERATED AIRCRAFT AND ATC COMMUNICATIONS,” the disclosure of which is incorporated by reference herein in its entirety for all purposes.

### TECHNICAL FIELD

This disclosure generally relates to aircraft communications and particularly to consolidation of air-to-ground voice links for remotely supervised aircraft and air traffic control (ATC) communications and voice communications in untowered airspace on a common traffic advisory frequency (CTAF).

### BACKGROUND

Operations of remotely supervised aircraft may need to facilitate bidirectional voice communications between a ground supervisor and an ANSP's (air navigation service provider) ATC controller or other local air traffic. When an airline operates remotely supervised aircraft in a particular geographic area, there may be only a finite number of very high frequency (VHF) radio frequencies that may be used for communications between an ATC controller and ground supervisors. If a ground supervisor's voice is communicated to the ATC system by way of the aircraft (i.e., via aircraft relay), the ground supervisor's voice may be communicated from the ground operations center to the aircraft and then rebroadcast from the aircraft to the ATC system via VHF radio. However, simultaneous VHF transmissions may cause audio distortions, and the number of non-VHF radio links between the airline ground operations center and the aircraft may use resources and may consume significant amounts of communications service provider (CSP) air-ground spectrum needed in ATC voice communications.

Thus, there is a need for solutions that address the challenges and problems encumbering communications between remotely supervised aircraft and an ATC controller. This and other needs are addressed by the present disclosure.

### BRIEF SUMMARY

Certain embodiments of the present disclosure relate generally to aircraft communications and particularly to consolidation of air-to-ground voice links for remotely supervised aircraft and ATC communications and voice communications in untowered airspace on a CTAF.

In one aspect, a method may facilitate air/ground voice links for remotely supervised aircraft and air traffic control communications. The method may include one or a combination of the following. A 3-dimensional (3D) geometry of a radio frequency (RF) service volume may be determined by an operator entity system monitoring a plurality of aircraft. Position information indicating a current position for each aircraft of the plurality of aircraft may be received by the operator entity system. Based at least in part on the 3D geometry of the RF service volume and the position information, the operator entity system may determine that at least a subset of aircraft of the plurality of aircraft is within the RF service volume. One aircraft of the subset of aircraft may be selected by the operator entity system as an airborne repeater within the RF service volume. Routing of voice communications between one or more ground supervisor terminals and an ATC) system for the subset of aircraft may be consolidated by the operator entity system. The consolidating may include deactivating any air/ground voice link associated with aircraft of the subset of aircraft other than the one aircraft selected as the airborne repeater.

In another aspect, a method may facilitate air/ground voice links for remotely supervised aircraft and air traffic control communications. The system may include one or more processing devices and memory communicatively coupled with and readable by the one or more processing devices and having stored therein processor-readable instructions which, when executed by the one or more processing devices, cause the one or more processing devices to perform one or a combination of the following operations. A 3D geometry of a RF service volume may be determined. Position information indicating a current position for each aircraft of a plurality of aircraft may be received. Based at least in part on the 3D geometry of the RF service volume and the position information, at least a subset of aircraft of the plurality of aircraft may be determined to be within the RF service volume. One aircraft of the subset of aircraft may be selected as an airborne repeater within the RF service volume. Routing of voice communications between one or more ground supervisor terminals and an ATC system for the subset of aircraft may be consolidated. The consolidating may include deactivating any air/ground voice link associated with aircraft of the subset of aircraft other than the one aircraft selected as the airborne repeater.

In yet another aspect, one or more non-transitory, machine-readable media may have machine-readable instructions thereon which, when executed by one or more processing devices, cause the one or more processing devices to perform one or a combination of the following operations. A 3D geometry of a RF service volume may be determined. Position information indicating a current position for each aircraft of a plurality of aircraft may be received. Based at least in part on the 3D geometry of the RF service volume and the position information, at least a subset of aircraft of the plurality of aircraft may be determined to be within the RF service volume. One aircraft of the subset of aircraft may be selected as an airborne repeater within the RF service volume. Routing of voice communications between one or more ground supervisor terminals and an ATC system for the subset of aircraft may be consolidated. The consolidating may include deactivating any air/ground voice link associated with aircraft of the subset of aircraft other than the one aircraft selected as the airborne repeater.

In various embodiments, the selecting the one aircraft as the airborne repeater may be based at least in part on the position information. In various embodiments, the consolidating may be performed during a time period when one or more aircraft of the subset of aircraft are in the RF service volume. In various embodiments, the selecting the one aircraft as the airborne repeater may be based at least in part on predicted times in the RF service volume for each aircraft of the subset of aircraft. In various embodiments, the voice communications for the subset of aircraft may be caused to utilize an air/ground voice link associated with the one aircraft selected as the airborne repeater. In various embodiments, the routing of the voice communications between the one or more ground supervisor terminals and the ATC system may be changed when the selected one aircraft transits to a different RF service volume.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an overview of a voice communications system for voice communications between a ground supervisor and air traffic control (ATC), in accordance with certain embodiments according to the present disclosure.

FIG. 2 illustrates a voice communications system using default unconsolidated voice links for voice communications between one or more ground supervisors and an ATC system juxtaposed with the voice communications system using consolidated voice links for voice communications between the one or more ground supervisors and the ATC system, in accordance with embodiments according to the present disclosure.

FIG. 3 illustrates a radio frequency (RF) service volume diagram, in accordance with embodiments according to the present disclosure.

FIG. 4 illustrates the RF service volume diagram with aircraft in different positions, in accordance with embodiments according to the present disclosure.

FIG. 5 illustrates one example method for facilitating air/ground (A/G) voice links for remotely supervised aircraft and ATC communications, in accordance with embodiments of the present disclosure.

FIG. 6 illustrates aspects of a computer system that may be incorporated as part of the operator entity system, the ground control station (GCS), and/or other components of the voice communications system, in accordance with embodiments of this disclosure.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

Disclosed embodiments may provide various features relating to voice link consolidation with respect to voice exchanges between an operator of a remotely supervised, autonomous and uncrewed aircraft and an air navigation service provider (ANSP). Advantageously, the consolidated voice links features according to the present disclosure may significantly reduce communications links resource usage when multiple aircraft are operating in the same ATC radio frequency sector. The consolidated voice links features may also eliminate audio echoes and distortions a ground supervisor may experience when multiple aircraft receive very high frequency (VHF) transmissions from the ATC and other proximate aircraft. Additionally, the consolidated voice links features may reduce the amount of spectrum used to facilitate air/ground (A/G) voice communications between a ground control station (GCS) and aircraft. The consolidated voice links features also may permit resilient voice routing. Accordingly, disclosed embodiments may reduce resource usage, may reduce audio distortions, may improve resiliency due to system failure, and may reduce the amount of communications service provider (CSP) air-ground spectrum needed in ATC voice communications.

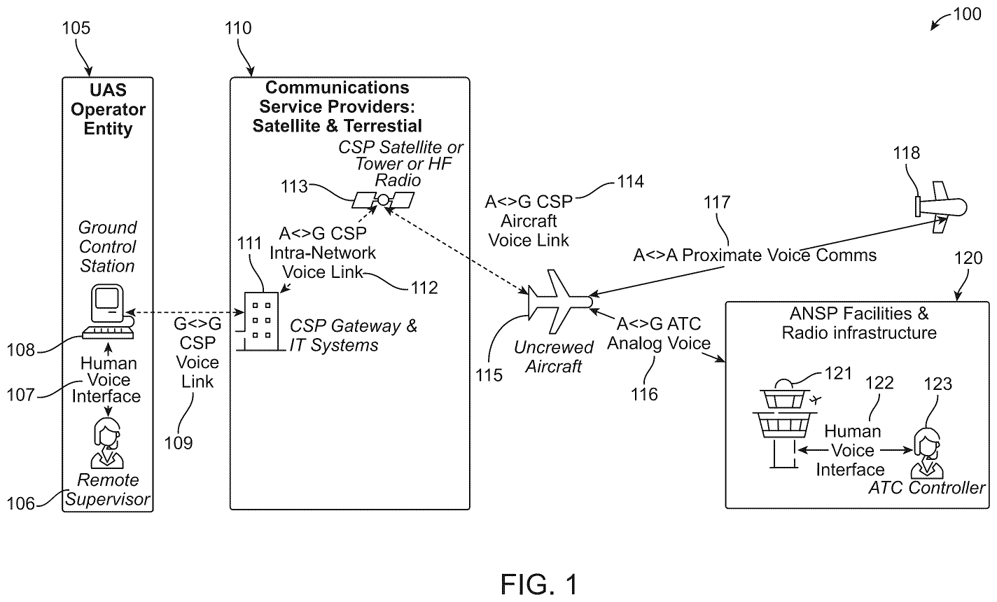

Various embodiments will now be discussed in greater detail with reference to the accompanying figures, beginning with FIG. 1

FIG. 1 illustrates an overview of a voice communications system 100 for voice communications between a ground supervisor and an ATC, in accordance with certain embodiments according to the present disclosure. The voice communications system 100 may include one or more unmanned aircraft system (UAS) operator entity systems 105, one or more communications service providers (CSPs) 110, one or more remotely supervised, autonomous and uncrewed aircraft 115 (aircraft 115), and ANSP facilities and radio infrastructure 120. In the example U A S operator entity system 105 (operator entity system 105) depicted, the UAS operator entity system 105 may include a ground supervisor 106 and a ground control station (GCS) 108. In the example communications service provider (CSP) 110 depicted, the CSP 110 may include terrestrial and satellite components. Such components may include terrestrial communications infrastructure 111, such as CSP gateway and information (IT) systems. Such components may also include air-ground (A< >G) communications infrastructure 113, such as a CSP satellite, tower, and/or high frequency (HF) radio. The ANSP facilities and radio infrastructure 120 may include an ATC system 121 and an ATC controller 123.

In general, aircraft voice relay may work in the following manner, for the case in which the direction from the ground supervisor 106 to the ATC controller 123. A human voice interface 107 may communicatively couple the ground supervisor 106 with the GCS 108. Voice from speech of the ground supervisor 106 may be converted from an analog format to a digital format via encoding, e.g., with the human voice interface 107 at a ground supervisor workstation within the GCS 108.

The digitally encoded voice may be sent to the aircraft 115 from the GCS 108 over one or more communications links to the aircraft 115. The CSP 110 may be used to link the GCS 108 and the aircraft 115. A ground-to-ground (G< >G) CSP voice link 109 may communicatively couple the GCS 108 with the terrestrial communications infrastructure 111. An A< >G CSP intra-network voice link 112 may communicatively couple the terrestrial communications infrastructure 111 with the A< >G communications infrastructure 113. An A< >G CSP aircraft voice link 114 may communicatively couple the A< >G communications infrastructure 113 with the aircraft 115.

At the aircraft 115, the digitally encoded voice may be converted to an analog format. The ground supervisor's voice may then be transmitted by the aircraft's VHF radio. An A< >G ATC analog voice link 116 may communicatively couple the aircraft 115 with the ATC system 121. One or more ground receivers of the ANSP facilities and radio infrastructure 120 may receive the analog VHF radio frequency (RF) signals. A human voice interface 122 may communicatively couple the ATC system 121 with the ATC controller 123. The ATC system 121 may use the human voice interface 122 to process the analog voice signals and provide analog audio into a listening device of the ATC controller 123, such as a headset. The process of providing voice communications from the ATC controller 123 to the ground supervisor 106 may work in the opposite direction as described above.

Disclosed embodiments may not only be applicable to satellite communications links to aircraft but also to other link types. Embodiments according to the present disclosure may be applicable to any type of communications method used to transport ATC voice via the aircraft relay method where resource efficiency and spectrum efficiency is desired. Communications links between a UAS operator's GCS 108 and aircraft 115 may be physically implemented in a number of different ways: a simple point-to-point RF link, or via a CSP 110 that has a network of transmitters and receivers, such as a satellite provider, or a terrestrial network such as a cellular mobile network operator. For example, the A< >G CSP intra-network voice link 112 may correspond to an HF radio transporting voice in any propagation path. In that example, the A< >G link between the HF transceiver of the A< >G communications infrastructure 113 and the aircraft 115 may utilize the same HF frequency for all aircraft operating in the same VHF frequency.

With consolidated voice links, for all aircraft 115 of a particular operator entity system 105 flying in the same RF service volume, all ground supervisor 106 voice transmissions may be transported by only one active air-to-ground voice link 114 to only one aircraft 115. All ATC voice transmissions may be transported by only one active air-to-ground voice link to the one aircraft 115. Additionally, all proximate air-to-air (A< >A) aircraft pilot voice communications 117 from other aircraft 118 (that, for example, may not be operated by the operator entity system 105 and may not be remotely operated) may be transported via the one active air-to-ground voice link to the one aircraft 115.

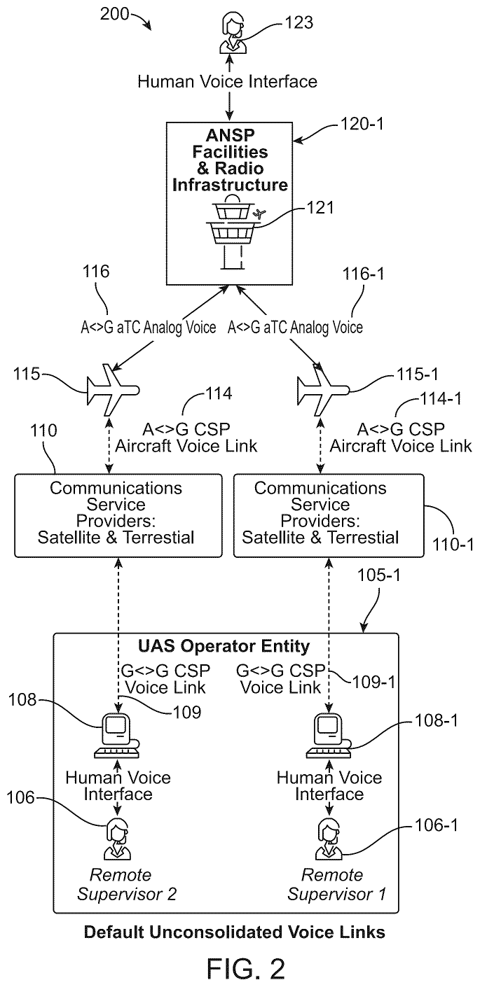

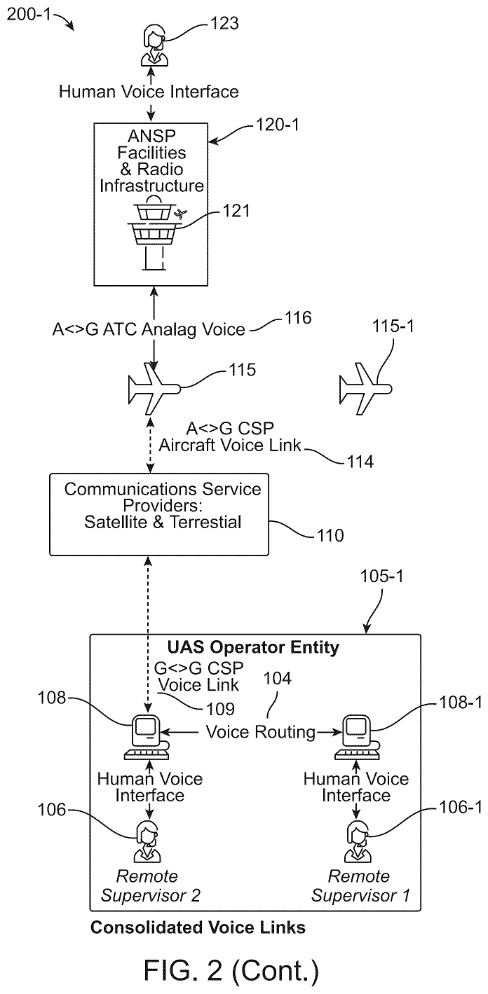

The consolidated voice link mode may be effected when there are multiple aircraft 115 operating in a particular region on a particular VHF frequency. The illustration of FIG. 1 shows only one remotely supervised aircraft 115. However, the consolidated voice link mode may be illustrated with respect to FIG. 2.

FIG. 2 illustrates a voice communications system 200 using default unconsolidated voice links for voice communications between one or more ground supervisors 106 and the ATC system 121 juxtaposed with the voice communications system 200-1 using consolidated voice links for voice communications between the one or more ground supervisors 106 and the ATC system 121, in accordance with embodiments according to the present disclosure. The voice communications system 200 may generally correspond to the voice communications system 100 but is illustrated with different numbers of components and may be configured to operate in a first mode corresponding to unconsolidated voice links. In an unconsolidated voice links mode, there may be two or more separate satellite communication voice links.

However, with disclosed embodiments, if multiple aircraft 115 are operating on the same VHF frequency in the same area, a separate voice communications link between every ground supervisor 106 and every remote aircraft 115 operating on the same frequency may not be necessary. Disclosed embodiments may provide for consolidating all the voice communications links to one aircraft 115 that may operate as a transmitter that rebroadcasts out to the ATC 121. For example, if there are four aircraft 115 operated by four different ground supervisors 106, all ground supervisor voice transactions may be relayed through one communications link while the aircraft 115 that operates as a transmitter is in a particular frequency coverage zone. This may be facilitated due to ATC voice transactions being highly structured and only allowing one person to speak at a time, as there is no duplex communication.

In the example of FIG. 2, two aircraft 115, 115-1 are illustrated in the voice communications system 200. In the example depicted, the voice communications system 200 is illustrated the unconsolidated voice link mode as including two CSPs 110, 110-1, with CSP 110 providing an A< >G CSP aircraft voice link 114 to the aircraft 115 and CSP 110-1 providing an A< >G CSP aircraft voice link 114-1 to the aircraft 115-1. However, in other embodiments, there may be only one CSP 110 providing both A< >G CSP aircraft voice links 114, 114-1 respectively to the aircraft 115, 115-1.

Likewise, in the example depicted, the operator entity system 105-1 is illustrated as including two ground supervisors 106, 106-1 and two GCSs 108, 108-1. However, in other embodiments, there may be only one ground supervisor 106 and/or only one GCS 108 remotely operating both aircraft 115, 115-1 with multiple G< >G CSP voice links 109, 109-1. Thus, various embodiments not shown, there may be only one ground supervisor 106 controlling multiple aircraft 115. Furthermore, it is to be understood that, even though an example of just two aircraft 115 is used herein for the sake of simplicity of description, disclosed embodiments may be applied to cases of more than two aircraft 115 and, indeed, many more than just two aircraft 115.

Disclosed embodiments may be configured to perform a method of consolidating ATC voice links applicable to remotely supervised aircraft (e.g., 115, 115-1, or more aircraft not shown) relaying voice communications between the ATC controller 123 and one or more ground supervisors (e.g., 106, 106-1, or more not shown). According to that method, the voice communication system 200 may transition from the unconsolidated voice links mode to the consolidated voice links mode. The state of the voice communication system 200 in the consolidated voice links mode is represented by the voice communications system 200-1. Thus, the voice communications system 200-1 may correspond to the voice communications system 200 after being configured to operate in a second mode corresponding to consolidated voice links.

With the voice communications system 200-1 in the consolidated voice links mode, only one G< >G CSP voice link 109 may be needed, and only one A< >G CSP aircraft voice link 114 may be needed. The operator entity system 105-1 (e.g., GCS 108 and/or GCS 108-1) on the ground may be configured with the logic to cause the transitioning from the unconsolidated voice links mode to the consolidated voice links mode. In the consolidated voice links mode illustrated, the operator entity system 105-1 has selected the aircraft 115 as the sole repeater and has designated the aircraft 115-1 as a non-repeater aircraft.

In the state of the voice communications system 200-1 illustrated, the operator entity system 105-1 has caused the voice link to the non-repeater aircraft 115-1 through the CSP 110-1 (which could be the same as CSP 110 in some embodiments) to be dropped. In some cases where a satellite communications line has an address mapped to a telephone number and/or an International Mobile Equipment Identity (IMEI) tag assigned to a telephone number, the dropping of the satellite communications voice link may correspond to hanging up or otherwise terminating a call (or, in the case of transitioning to another mode or to another repeater, a satellite communications voice link may be established, which may correspond to dialing a phone number while ensuring that a make-before-break protocol is observed so that a link has been established for a predetermined amount of time before an existing link is dropped because it might take 15 seconds or more to establish the new link). Accordingly, the A< >G CSP aircraft voice link 114-1 and the G< >G CSP voice link 109-1 have been dropped in the consolidated voice links mode. With that voice link dropped, there may be no separate transferring of voice messages either from the ground supervisor 106-1 or from the ATC controller 123, so there is no longer resource usage associated with keeping that link open. Instead, all voice transactions from the ground supervisor 106-1, from the ATC controller 123, and from the ground supervisor 106-1 may be consolidated such that voice messages are transferred only by way of the remaining voice link, the components of which include the A< >G CSP aircraft voice link 114 and the G< >G CSP voice link 109. For the non-repeater aircraft 115-1, there may still be VHF radio communications to the aircraft 115-1, for example, for command and control (C2) data and telemetry communications via a command control data link that may remain active via a satellite communications modem of the aircraft, but no satellite communication voice link corresponding to the satellite communications phone voice relay channel that existed previously in the unconsolidated voice link state.

Additionally, at the operator entity system 105-1, the GCSs 108, 108-1 may be communicatively coupled (e.g., via a network 104) so that all voice communications received or transmitted via the one consolidated voice link are communicated to the GCSs 108, 108-1 and audible to the ground supervisors 106, 106-1. This may correspond to a voice net, a voice loop, and/or the like. For example, voice communications from the ATC controller 123 directed to the aircraft 115 and the ground supervisor 106 may be heard by the ground supervisor 106-1. Likewise, voice communications from the ATC controller 123 directed to the aircraft 115-1 and the ground supervisor 106-1 may be heard by the ground supervisor 106.

The consolidated voice links features according to the present disclosure may be viable at least in part because only one person (e.g., only one of the ground supervisors 106 or 106-1, a pilot of another aircraft that is not remotely operated/supervised, or the ATC controller 123) is able to speak on a given VHF frequency at a time. This may be due to aviation radio voice communication being half-duplex. Moreover, by definition, any remotely supervised aircraft within an RF service volume may have radio line of sight with the ANSP radio infrastructure 120-1. Further, within the UAS operator entity system 105-1, a voice communication system may connect all ground supervisors 106, 106-1 (or more) within the facility. The voice communications system may connect with the air-to-ground voice link, whether implemented as a point-to-point radio or by a networked CSP 114.

The consolidated voice links features according to the present disclosure may significantly reduce communications links resource usage when multiple aircraft 115 are operating in the same ATC radio frequency sector. The consolidated voice links method may reduce the expense associated with transporting bidirectional voice between the ATC 121 and a ground supervisor 106-1 via the aircraft 115-1. For example, if a satellite CSP entity charges by the minute for use of a voice link between the GCS 108-1 and the aircraft 115-1, link resource usage may be reduced as only one aircraft 115 needs to relay the bidirectional ATC voice communication. As such, the illustrated example may treat the aircraft 115 as a “repeater in the sky” when the multiple aircraft 115, 115-1 are operating simultaneously in the same RF service volume associated with one RF frequency.

The consolidated voice links method may also eliminate audio echoes and distortions a ground supervisor 106 or 106-1 may experience when multiple aircraft receive VHF transmissions from the ATC 121 and other proximate aircraft (e.g., aircraft 118 illustrated in FIG. 1). For example, if both aircraft 115, 115-1 receive VHF transmissions from the same source, small differences in link latency may cause echo effects when both audio streams are annunciated to a ground supervisor 106 or 106-1. Additionally, the consolidated voice links method may reduce the amount of CSP-provided spectrum used to facilitate A/G voice communications between the GCS 108-1 and the aircraft 115-1. The consolidated voice links method also may permit resilient voice routing. Should an A/G voice link fail on one aircraft 115 or 115-1, another aircraft (e.g., the other of the two aircraft 115, 115-1) in the same RF service volume may be used to relay ATC voice.

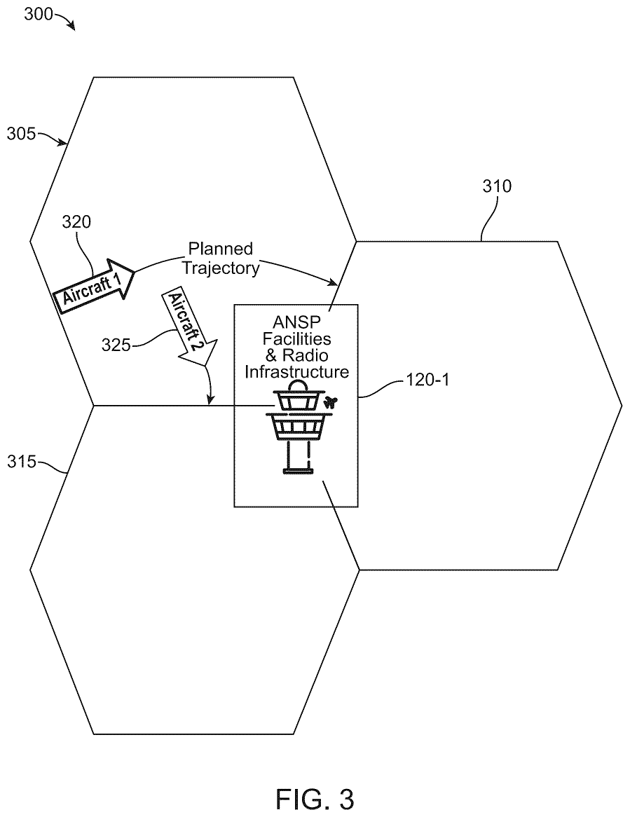

FIG. 3 illustrates an RF service volume diagram 300, in accordance with embodiments according to the present disclosure. The consolidated voice link method may be based at least in part on the operator entity system 105-1 determining what VHF frequency aircraft 115 are on and what VHF frequency the aircraft 115 should be on. Once that is determined, the operator entity system 105-1 may control routing of communications, which may include switching voice paths at multiple ground stations to specify communications with a particular aircraft 115 to implement the consolidated voice link method.

The consolidated voice link method may be based at least in part on a geometry of a RF service volume. The operator entity system 105-1 may define, specify, or otherwise determine the geometry of the RF service volume. This may include determining the 3-dimensional (3D) dimensions of the volume. For example, in some embodiments, the RF service volume may be a 3D hexagon of a set width and height. The geometry of the RF service volume may be provided directly by the ANSP and/or from a derivation via in-situ aircraft measurement and real-world ATC practice regarding when frequency changes are directed. In some embodiments, based on the particulars of the operating environment (topology) and deployment of ANSP communications infrastructure, each of the RF service volumes may be a complex geometric shape. A 3D hexagon is used here as an example.

Additionally, the consolidated voice link method may be based at least in part on a current position (3D point) of all remotely supervised aircraft 115. The operator entity system 105-1 may determine the position of each aircraft 115 as reported by the aircraft 115 via telemetry. The aircraft 115 may report through telemetry that can come through a satellite and or a ground network of radios. The reported telemetry information may include aircraft identifier (ID), latitude, longitude, altitude, speed, heading, status, and/or the like. Additionally or alternatively, the location information may be received by the operator entity system 105-1 from a third party, such as location information based on measurement provided by airspace surveillance systems.

Further, the consolidated voice link method may be based at least in part on planned, expected future trajectories (i.e., four-dimensional (4D) information corresponding to position, altitude, and time) of all aircraft 115 across all RF service volumes within an operational environment. The operator entity system 105-1 may determine the trajectories and use the trajectories to facilitate ground supervisor voice path configuration changes from one RF service volume to another RF service volume, depending on for which aircraft 115 particular ground supervisors 115 are responsible.

The operator entity system 105-1 may be configured to manage, in real time, the following key bi-directional ATC voice parameters. The operator entity system 105-1 may control whether a particular aircraft 115 is serving as an airborne repeater within the RF service volume such that the particular aircraft 115 may be designated as an active repeater. The operator entity system 105-1 may control whether the particular aircraft 115 is not being used as a repeater such that the particular aircraft 115 may be designated as a standby repeater. Accordingly, the operator entity system 105-1 may have determined whether there are no active repeaters within a particular RF service volume or whether a particular aircraft 115 is currently acting as an active repeater.

The operator entity system 105-1 may also control whether the particular aircraft 115 is not participating in the consolidated link method. For example, a non-participating aircraft 115 may be operating in default mode. In some cases, two or more aircraft 115 may operate in the consolidated voice links mode while one or more other aircraft 115 may operate in the default mode even though in the same service volume and operating on the same frequency as the participating aircraft 115.

The operator entity system 105-1 may control whether an air-to-ground voice link to a particular aircraft 115 is currently established. The operator entity system 105-1 may control the VHF frequency the aircraft radio is configured to transmit and receive on. This may be independent as to whether the aircraft 115 is assigned as an active or standby repeater. The operator entity system 105-1 may be configured to use a voice routing algorithm that controls how voice transactions of a ground supervisor 106 (corresponding to talking and listening) are routed to/from which active aircraft 115 based on the location of other aircraft 115 assigned to the ground supervisor 106 in the same RF service volume.

As illustrated in FIG. 3, the RF service volume diagram 300 may include service volume 305, service volume 310, and service volume 315. The service volumes 305, 310, 315 illustrated as hexagons may represent RF coverage service volumes generated by an ANSP's terrestrial transmitters, typically VHF or ultra-high frequency (UHF). Each of the service volumes 305, 310, 315 may represent a different RF frequency used in a particular volume of airspace. The hexagons may not represent an exact radio frequency service volume but instead may be used for illustrative purposes only. The arrowhead of arrow 320 may represent the current aircraft location for aircraft 1. Likewise, the arrow head of arrow 325 may represent the current aircraft location for aircraft 2. The tails of the arrows 320, 325 may respectively represent past travel of aircraft 1 and aircraft 2. The dotted lines may represent the planned direction of travel for each aircraft. Altitude is not shown on this diagram but will be discussed later.

Say that a ground supervisor is supervising one aircraft in controlled airspace corresponding to service volume 305. The aircraft, based on ATC directive, may use a particular frequency to relay voice to ATC. Aircraft 1 is depicted in service volume 305 that is associated with a first VHF frequency. In this case, the ground supervisor may have no choice but to send all voice to ATC by relaying via aircraft 1 on the first VHF frequency.

Now, say that the ground supervisor is operating two aircraft in the service volume 305. Either the same ground supervisor may be operating the same two aircraft, or two different ground supervisors may be assigned one aircraft each. In this situation, both ground supervisors may be listening to the radio frequency associated with the service volume 305 and speaking when appropriate.

To initiate the consolidated voice link mode, the operator entity system 105-1 may first determine the condition of having multiple aircraft operating on a particular frequency. For example, the operator entity system 105-1 may determine whether aircraft 1 and aircraft 2 are going to the same vertiport on the same frequency on the same flight path or whether one or more of the aircraft 1 and aircraft 2 are transitioning to a second VHF frequency mapped to service volume 315, for example. The operator entity system 105-1 may have a choice with respect to the simultaneous utilization of both voice links between the GCS 108 and the two aircraft, with the following two schemes. In operational practice, both schemes may be employed during the course of a single aircraft flight, as illustrated herein.

1. Simultaneous Voice Links: During the time period in which aircraft 1 and aircraft 2 are in the service volume 305, bidirectional voice between ground supervisor(s) and ATC controller may be transported by the CSP-provided air-to-ground voice links associated with both aircraft. This may be the “default option” where optimization is not attempted.

2. Consolidated Voice Link: During the time period in which aircraft 1 and aircraft 2 are in the service volume 305, bidirectional voice between ground supervisor and ATC controller may be transported by the links associated with just one aircraft. This may be an optimized option. For example, aircraft 1 may serve as an active repeater for aircraft 2.

Within a specific operating area, such as a large metropolitan area, a consolidated voice link may be implemented practically via the following method. For example, assume the following. Aircraft 1 is remotely supervised by ground supervisor in command 1 (which may be referenced as remote pilot in command 1 or RPIC 1). Aircraft 2 is remotely supervised by ground supervisor in command 2 (which may be referenced as remote pilot in command 2 or RPIC 2). All of the operators' aircraft may be initially using the default option as specified below:
a. RPIC 1< >A/G CSP Voice Link 1< >Aircraft 1< >Service Volume 305 ATC RF Frequency< >Service Volume 305 ATC Controller
b. RPIC 2< >A/G CSP Voice Link 2< >Aircraft 2< >Service Volume 305 ATC RF Frequency< >Service Volume 305 ATC Controller
c. For illustrative purposes only, each of the A/G voice links may be assumed to be like a satphone phone call between the GCS 108 and the aircraft.

By way of example, a consolidated voice link may be established as follows. The operator entity system 105-1 may be configured with a consolidated voice link manager (CVLM) algorithm that it uses to maintain a current data set of all applicable RF service volume geometries and relevant parameters. The operator entity system 105-1 configured with the CVLM algorithm may maintain a current data set of the current locations and planned trajectories of all of an operator's aircraft within an operating area. The operator entity system 105-1 configured with the CVLM algorithm may identify when two or more aircraft are currently operating in the same RF service volume. As illustrated, aircraft 1 and aircraft 2 are in service volume 305. The operator entity system 105-1 configured with the CVLM algorithm may calculate the amount of time both aircraft will be co-located in the same RF service volume based at least in part on planned trajectory information. If the amount of time is greater than a configurable threshold, the operator entity system 105-1 configured with the CVLM algorithm may determine which of the two aircraft has the longer amount of flight time remaining within the RF service volume 305.

Continuing with the example, assume that aircraft 1 has the longer amount of flight time remaining within the service volume 305. The operator entity system 105-1 configured with the CVLM algorithm may specify aircraft 1 as active and aircraft 2 as standby. In parallel within the ground control station, the operator entity system 105-1 configured with the CVLM algorithm may identify that the bidirectional voice communications associated with aircraft 2 and RPIC 2 need to utilize the voice path from aircraft 1. While aircraft 2 is in service volume 305, the voice communication system may route voice traffic as follows: RPIC 2< >A/G Voice Link 1< >Aircraft 1< >Service Volume 305 ATC RF Frequency< >Service Volume 305 ATC Controller. Once aircraft 1 is active, A/G Voice Link 2 may be deactivated. For example, a satphone phone call to aircraft 2 may be terminated after A/G Voice Link 1 has been active for a predetermined time. The time that there is no use of an A/G Voice Link 2 may represent a resource usage savings over the default option.

Thus, in some embodiments, the operator entity system 105-1 may determine which aircraft in a particular frequency zone is to be configured as the sole repeater based at least in part on flight paths such that the sole repeater aircraft may be the aircraft that is predicted to spend the longest amount of time in the particular frequency zone (e.g., operating on frequency 123.x). In addition or in alternative, in various embodiments, the operator entity system 105-1 may determine which aircraft in the particular frequency zone is to be configured as the sole repeater based at least in part on the aircraft has the best voice characteristics for any suitable reasons. For example, the sole repeater may be selected based at least in part on which aircraft has the best radio line of sight with the ANSP radio infrastructure 120-1. Factors such as altitude and potential interference (e.g., tall buildings, mountains, etc.) may be taken into account in determining which aircraft has the best line of sight.

In some embodiments, the operator entity system 105-1 may score each of a plurality of factors (e.g., time predicted to be in the particular frequency zone, radio line of sight with the ANSP radio infrastructure 120-1, altitude, potential interference, and/or the like) for each aircraft. Then, the operator entity system 105-1 may select a particular aircraft to be configured as the sole repeater based at least in part on cumulative scores of each aircraft. For example, the operator entity system 105-1 may select the aircraft with the highest cumulative score. In some embodiments, one or more of the factors may be weighted differently, such that, for example, some factors are weighted more heavily than others. For example, voice characteristics factors may be weighted more heavily than predicted time in service volume. Other embodiments are possible.

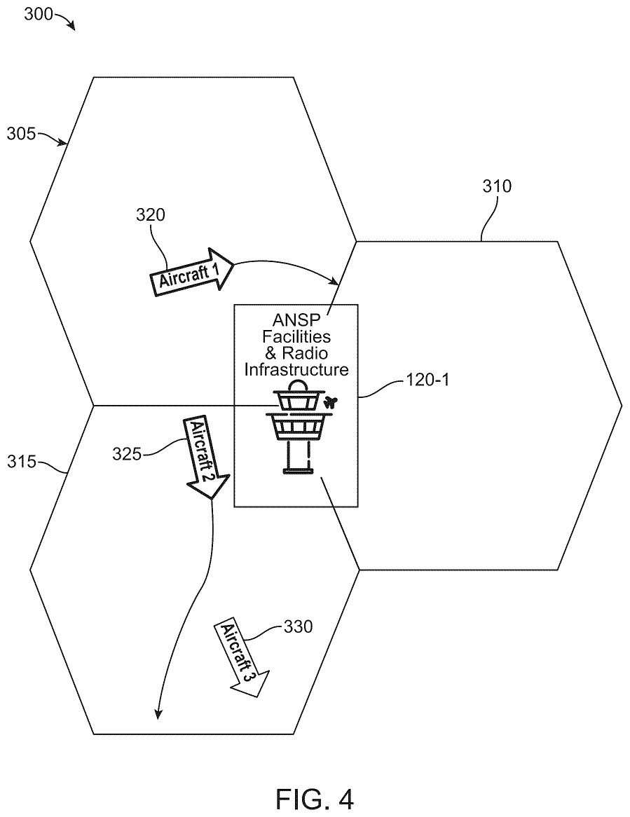

FIG. 4 illustrates the RF service volume diagram 300 with aircraft in different positions, in accordance with embodiments according to the present disclosure. For example, the arrow 320 representing aircraft 1 and the arrow 325 representing aircraft 2 are in different positions. Additionally, an arrow 330 may represent another aircraft, aircraft 3, in the service volume 315.

Continuing with the example with aircraft 2 exiting the service volume 305 and transiting to the service volume 315, aircraft 1 may remain active on the frequency mapped to the service volume 305. Aircraft 2's onboard radio may be configured to the frequency mapped to the service volume 315 either by ground command or onboard avionics command. The operator entity system 105-1 configured with the CVLM algorithm may determine that aircraft 2 and aircraft 3 are now in the same RF service volume 315. The operator entity system 105-1 configured with the CVLM algorithm may determine that aircraft 2 will be in the service volume 315 longer than aircraft 3. The operator entity system 105-1 configured with the CVLM algorithm may transition aircraft 2 from standby to active and may transition aircraft 3 from active to standby. Thus, aircraft 2 may serve as an active repeater for aircraft 3. Voice routing may now correspond to:
1. RPIC 2< >A/G Voice Link 2< >Aircraft 2< >Service Volume 315 ATC Frequency< >Service Volume 315 ATC Controller; and
2. RPIC 3< >A/G Voice Link 2< >Aircraft 2< >Service Volume 315 RF ATC Frequency< >Service Volume 315 ATC Controller.

Just like above, the time that RPIC 2 and RPIC 3 are sharing the A/G link via aircraft 2 may represent a resource usage savings as well as a reduction in audio distortion. To repeat, this scheme may only apply to situations where there are two or more aircraft operating in the same RF service volume. Should any aircraft be the only aircraft in the RF service volume, the bi-directional voice configuration may be set to default.

As disclosed above, in some embodiments, the determination of which aircraft should be the sole repeater may be based at least in part on flight paths such that the sole repeater aircraft may be the aircraft that is predicted to spend the longest amount of time in the frequency zone. For example, if aircraft 1 just entered the frequency zone and aircraft 2 is about to leave the frequency zone, aircraft 1 may be designated as the repeater. Further, as disclosed above, various embodiments may additionally or alternatively determine which aircraft is going to be the sole repeater because the aircraft has the best voice characteristics.

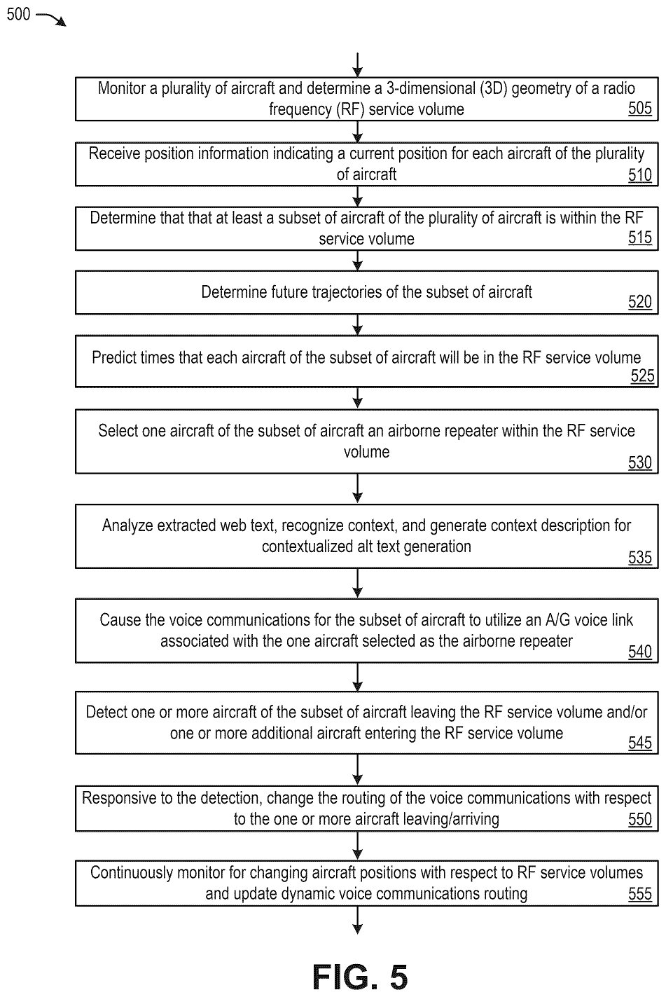

Accordingly, FIG. 5 illustrates one example method 500 for facilitating A/G voice links for remotely supervised aircraft and ATC communications, in accordance with embodiments of the present disclosure. One or a combination of the aspects of the method 500 may be performed in conjunction with one or more other aspects disclosed herein, and the method 500 is to be interpreted in view of other features disclosed herein and may be combined with one or more of such features in various embodiments. Teachings of the present disclosure may be implemented in a variety of configurations that may correspond to the configurations disclosed herein. As such, certain aspects of the methods disclosed herein may be omitted, and the order of the steps may be shuffled in any suitable manner and may depend on the implementation chosen. Moreover, while the aspects of the methods disclosed herein, may be separated for the sake of description, it should be understood that certain steps may be performed simultaneously or substantially simultaneously.

As indicated by block 505, the operator entity system 105 may monitor a plurality of aircraft 115 and may determine a 3D geometry of a RF service volume. As indicated by block 510, the operator entity system 105 may receive position information indicating a current position for each aircraft 115 of the plurality of aircraft 115. As indicated by block 515, the operator entity system 105 may determine that at least a subset of aircraft of the plurality of aircraft is within the RF service volume. The determination may be based at least in part on the 3D geometry of the RF service volume and the position information. In some embodiments, as indicated by block 520, the operator entity system 105 may determine future trajectories of the subset of aircraft 115. In some embodiments, as indicated by block 525, the operator entity system 105 may predict durations that each aircraft 115 of the subset of aircraft 115 will be in the RF service volume.

As indicated by block 530, the operator entity system 105 may select one aircraft 115 of the subset of aircraft 115 as an airborne repeater within the RF service volume. The selecting the one aircraft 115 as the airborne repeater may be based at least in part on the position information indicating the current positions of the plurality of aircraft 115. Additionally or alternatively, the selecting the one aircraft 115 as the airborne repeater may be based at least in part on the future trajectories of the plurality of aircraft 115. For example, the operator entity system 105 may select the one aircraft 115 as the airborne repeater based at least in part on the predicted times in the RF service volume for each aircraft 115 of the subset of aircraft 115 (e.g., how long each aircraft 115 is predicted to be in the RF service volume).

As indicated by block 535, the operator entity system 105 may consolidate routing of voice communications between one or more ground supervisor terminals (e.g., one or more GCSs 108) and the ATC system 121 for the subset of aircraft 115. The consolidating may include deactivating any A/G voice link associated with aircraft 115 of the subset of aircraft 115 other than the one aircraft 115 selected as the airborne repeater. The consolidating may be performed during a time period when one or more aircraft 115 of the subset of aircraft 115 are in the RF service volume (e.g., only when the one or more aircraft 115 are in the RF service volume, in some embodiments). In some embodiments, as indicated by block 540, the consolidating may include the operator entity system 105 causing the voice communications for the subset of aircraft 115 to utilize an A/G voice link associated with the one aircraft 115 selected as the airborne repeater.

As indicated by block 545, the operator entity system 105 may detect one or more aircraft 115 of the subset of aircraft 115 leaving the RF service volume (or determining that one or more aircraft 115 are predicted to leave within a particular temporal window) and/or one or more additional aircraft 115 entering the RF service volume (or determining that one or more aircraft 115 are predicted to enter within a particular temporal window). Responsive to the detection, the operator entity system 105 may change the routing of the voice communications with respect to the one or more aircraft 115 leaving/arriving, as indicated by block 550. This may include changing the routing of the voice communications between the one or more ground supervisor terminals and the ATC system 121 when one or more aircraft 115 leave and/or enter the RF service volume.

For example, in the case of one aircraft 115 leaving the RF service volume, the operator entity system 105 may determine whether there should be a new airborne repeater in the RF service volume using one or more of the factors disclosed above. If so, the operator entity system 105 may change the routing of the voice communications with respect to the aircraft 115 remaining in the RF service volume accordingly. However, in some embodiments, the previously selected one aircraft 115 may remain the airborne repeater until transits to a different RF service volume, at which point, the operator entity system 105 may determine that another aircraft 115 should be configured as the airborne repeater for the RF service volume, if there are one or more aircraft 115 in the RF service volume at the time. Additionally, the operator entity system 105 may determine whether there should be a new airborne repeater in the next RF service volume to which the leaving aircraft 115 transits. The operator entity system 105 may change routing for at least the aircraft 115 that transits to the next RF service volume so that it is configured as the airborne repeater for the next RF service volume or is configured to receive communications from another aircraft 115 in the next RF service volume. As indicated by block 555, the operator entity system 105 may continue to monitor for changing aircraft positions with respect to RF service volumes over time and update dynamic voice communications routing accordingly.

As an example for the case of an additional aircraft 115 entering the RF service volume, the operator entity system 105 may determine whether there should be a new airborne repeater in the RF service volume using one or more of the factors disclosed above. If so, the operator entity system 105 may change the routing of the voice communications with respect to the updated subset of aircraft 115 in the RF service volume accordingly. The operator entity system 105 may determine whether change routing for at least the additional aircraft 115 that enters the RF service volume, as it may be configured as the airborne repeater for the RF service volume or may be configured to receive communications from another aircraft 115 in the RF service volume. Again, as indicated by block 555, the operator entity system 105 may continue to monitor for changing aircraft positions with respect to RF service volumes over time and update dynamic voice communications routing accordingly.

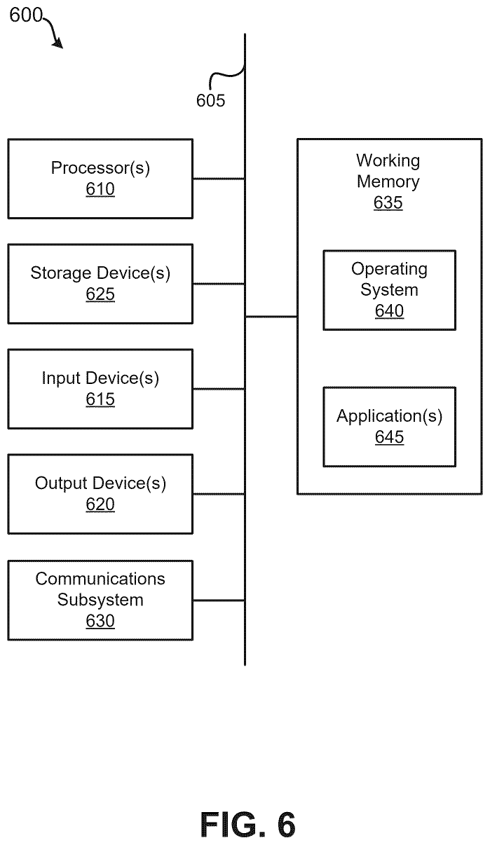

FIG. 6 illustrates aspects of a computer system 600 that may be incorporated as part of the operator entity system 105, the GCS 108, and/or other components of the voice communications system 100, in accordance with embodiments of this disclosure. FIG. 6 provides a schematic illustration of one embodiment of a computer system 600 that can perform various steps of the methods provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, video decoders, and/or the like); one or more input devices 615, which can include without limitation a mouse, a keyboard, remote control, and/or the like; and one or more output devices 620, which can include without limitation a display device, a printer, and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device, and/or a chipset (such as a Bluetooth™ device, an 802.11 device, a Wi-Fi device, a WiMAX device, cellular communication device, etc.), and/or the like. The communications subsystem 630 may permit data to be exchanged with a network (such as the network described below, to name one example), other computer systems, and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640, device drivers, executable libraries, and/or other code (e.g., to configure the computer system 600 with the CVLM algorithm), such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code, including instructions and/or code to configure the computer system 600 with the CVLM algorithm, may be stored on a non-transitory computer-readable storage medium, such as the non-transitory storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure, and/or adapt a general-purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the non-transitory storage device(s) 625. Merely by way of example, execution of the sequences of instructions contained in the working memory 635 might cause the processor(s) 610 to perform one or more procedures of the methods described herein.

The terms “machine-readable medium,” “computer-readable storage medium,” “computer-readable medium,” and that plural forms thereof as used herein, refer to any medium or media that participate in providing data that causes a machine to operate in a specific fashion. These mediums may be non-transitory. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of non-volatile media or volatile media. Non-volatile media include, for example, optical and/or magnetic disks, such as the non-transitory storage device(s) 625. Volatile media include, without limitation, dynamic memory, such as the working memory 635.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 (and/or components thereof) generally will receive signals, and the bus 605 then might carry the signals (and/or the data, instructions, etc. carried by the signals) to the working memory 635, from which the processor(s) 610 retrieves and executes the instructions. The instructions received by the working memory 635 may optionally be stored on a non-transitory storage device 625 either before or after execution by the processor(s) 610.

It should further be understood that the components of computer system 600 can be distributed across a network. For example, some processing may be performed in one location using a first processor while other processing may be performed by another processor remote from the first processor. Other components of computer system 500 may be similarly distributed. As such, computer system 500 may be interpreted as a distributed computing system that performs processing in multiple locations. In some instances, computer system 500 may be interpreted as a single computing device, such as a distinct laptop, desktop computer, or the like, depending on the context.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed:

1. A method of facilitating air/ground voice links for remotely supervised aircraft and air traffic control communications, the method comprising:
determining, by an operator entity system monitoring a plurality of aircraft, a 3-dimensional (3D) geometry of a radio frequency (RF) service volume;
receiving, by the operator entity system, position information indicating a current position for each aircraft of the plurality of aircraft;
based at least in part on the 3D geometry of the RF service volume and the position information, determining, by the operator entity system, that at least a subset of aircraft of the plurality of aircraft is within the RF service volume;
selecting, by the operator entity system, one aircraft of the subset of aircraft as an airborne repeater within the RF service volume; and
consolidating, by the operator entity system, routing of voice communications between one or more ground supervisor terminals and an air traffic control (ATC) system for the subset of aircraft, wherein the consolidating comprises deactivating any air/ground voice link associated with aircraft of the subset of aircraft other than the one aircraft selected as the airborne repeater.

2. The method of facilitating air/ground voice links for remotely supervised aircraft and air traffic control communications as recited in claim 1, wherein the selecting the one aircraft as the airborne repeater is based at least in part on the position information.

3. The method of facilitating air/ground voice links for remotely supervised aircraft and air traffic control communications as recited in claim 1, wherein the consolidating is performed during a time period when one or more aircraft of the subset of aircraft are in the RF service volume.

4. The method of facilitating air/ground voice links for remotely supervised aircraft and air traffic control communications as recited in claim 1, further comprising determining, by the operator entity system, future trajectories of the plurality of aircraft, wherein the selecting is based at least in part on the future trajectories.

5. The method of facilitating air/ground voice links for remotely supervised aircraft and air traffic control communications as recited in claim 4, wherein the selecting the one aircraft as the airborne repeater is based at least in part on predicted times in the RF service volume for each aircraft of the subset of aircraft.

6. The method of facilitating air/ground voice links for remotely supervised aircraft and air traffic control communications as recited in claim 1, further comprising causing the voice communications for the subset of aircraft to utilize an air/ground voice link associated with the one aircraft selected as the airborne repeater.

7. The method of facilitating air/ground voice links for remotely supervised aircraft and air traffic control communications as recited in claim 1, further comprising changing, by the operator entity system, the routing of the voice communications between the one or more ground supervisor terminals and the ATC system when the selected one aircraft transits to a different RF service volume.

8. A system to facilitate air/ground voice links for remotely supervised aircraft and air traffic control communications, the system comprising:
one or more processing devices; and
memory communicatively coupled with and readable by the one or more processing devices and having stored therein processor-readable instructions which, when executed by the one or more processing devices, cause the system to perform operations comprising:
determining a 3-dimensional (3D) geometry of a radio frequency (RF) service volume;
receiving position information indicating a current position for each aircraft of a plurality of aircraft;
based at least in part on the 3D geometry of the RF service volume and the position information, determining that at least a subset of aircraft of the plurality of aircraft is within the RF service volume;
selecting one aircraft of the subset of aircraft as an airborne repeater within the RF service volume; and
consolidating routing of voice communications between one or more ground supervisor terminals and an air traffic control (ATC) system for the subset of aircraft, wherein the consolidating comprises deactivating any air/ground voice link associated with aircraft of the subset of aircraft other than the one aircraft selected as the airborne repeater.

9. The system to facilitate air/ground voice links for remotely supervised aircraft and air traffic control communications as recited in claim 8, wherein the selecting the one aircraft as the airborne repeater is based at least in part on the position information.

10. The system to facilitate air/ground voice links for remotely supervised aircraft and air traffic control communications as recited in claim 8, wherein the consolidating is performed during a time period when one or more aircraft of the subset of aircraft are in the RF service volume.

11. The system to facilitate air/ground voice links for remotely supervised aircraft and air traffic control communications as recited in claim 8, the operations further comprising determining future trajectories of the plurality of aircraft, wherein the selecting is based at least in part on the future trajectories.

12. The system to facilitate air/ground voice links for remotely supervised aircraft and air traffic control communications as recited in claim 11, wherein the selecting the one aircraft as the airborne repeater is based at least in part on predicted times in the RF service volume for each aircraft of the subset of aircraft.

13. The system to facilitate air/ground voice links for remotely supervised aircraft and air traffic control communications as recited in claim 8, the operations further comprising causing the voice communications for the subset of aircraft to utilize an air/ground voice link associated with the one aircraft selected as the airborne repeater.

14. The system to facilitate air/ground voice links for remotely supervised aircraft and air traffic control communications as recited in claim 1, the operations further comprising changing the routing of the voice communications between the one or more ground supervisor terminals and the ATC system when the selected one aircraft transits to a different RF service volume.

15. One or more non-transitory, machine-readable media having machine-readable instructions thereon which, when executed by one or more processing devices, cause the one or more processing devices to perform operations comprising:
determining a 3-dimensional (3D) geometry of a radio frequency (RF) service volume;
receiving position information indicating a current position for each aircraft of a plurality of aircraft;
based at least in part on the 3D geometry of the RF service volume and the position information, determining that at least a subset of aircraft of the plurality of aircraft is within the RF service volume;
selecting one aircraft of the subset of aircraft as an airborne repeater within the RF service volume; and
consolidating routing of voice communications between one or more ground supervisor terminals and an air traffic control (ATC) system for the subset of aircraft, wherein the consolidating comprises deactivating any air/ground voice link associated with aircraft of the subset of aircraft other than the one aircraft selected as the airborne repeater.

16. The one or more non-transitory, machine-readable media as recited in claim 15, wherein the selecting the one aircraft as the airborne repeater is based at least in part on the position information.

17. The one or more non-transitory, machine-readable media as recited in claim 15, wherein the consolidating is performed during a time period when one or more aircraft of the subset of aircraft are in the RF service volume.

18. The one or more non-transitory, machine-readable media as recited in claim 15, the operations further comprising determining future trajectories of the plurality of aircraft, wherein the selecting is based at least in part on the future trajectories.

19. The one or more non-transitory, machine-readable media as recited in claim 18, wherein the selecting the one aircraft as the airborne repeater is based at least in part on predicted times in the RF service volume for each aircraft of the subset of aircraft.

20. The one or more non-transitory, machine-readable media as recited in claim 15, the operations further comprising causing the voice communications for the subset of aircraft to utilize an air/ground voice link associated with the one aircraft selected as the airborne repeater.
